(19) United States
(12) Patent Application Publication
(10) Pub. No.: US 2019/0079537 A1
(43) Pub. Date: Mar. 14, 2019

(54) AUTOMATIC GUIDED VEHICLE

(71) Applicant: HONDA MOTOR CO., LTD., Minato-ku, Tokyo (JP)

(72) Inventors: Toru Yoshida, Hagagun, Tochigi-ken (JP); Jun Araki, Hagagun, Tochigi-ken (JP); Michiaki Okubo, Hagagun, Tochigi-ken (JP); Hiroki Maemoto, Hagagun, Tochigi-ken (JP); Atsushi Nakajima, Hagagun, Tochigi-ken (JP); Hiroaki Akimoto, Hagagun, Tochigi-ken (JP)

(21) Appl. No.: 16/084,271

(22) PCT Filed: Dec. 14, 2016
(86) PCT No.: PCT/JP2016/087234

§ 371 Date: Sep. 12, 2018

(30) Foreign Application Priority Data
Mar. 17, 2016 (JP) 2016-054044

(51) Int. Cl. G05D 1/02

(52) U.S. Cl. CPC G05D 1/0263; G05D 2201/0216; G05D 1/0274

(57) ABSTRACT

A virtual guide sensor processing unit of an automatic guided vehicle (AGV) computes the position of a virtual guide tape on the basis of the position of the AGV which a vehicle body coordinate value calculation processing unit has computed, and virtual guide tape layout data. A guide sensor switching processing unit outputs to a vehicle body deviation degree calculation processing unit the position of a magnetic guide tape which a magnetic guide sensor has detected, or the position of the virtual guide tape which the virtual guide sensor processing unit has computed.

### TECHNICAL FIELD

The present invention relates to an automatic guided vehicle that can travel along a guide tape.

### BACKGROUND ART

Recently, an automatic guided vehicle has been known as an unmanned conveying carriage, which conveys articles such as parts or components.

In Japanese Laid-Open Patent Publication No. 08-234836, an automatic guided vehicle that travels along a magnetic guide tape by detecting the magnetic field of the magnetic guide tape which is laid on a traveling path is disclosed.

Moreover, in Japanese Laid-Open Patent Publication No. 09-230933 and Japanese Laid-Open Patent Publication No. 10-149217, a technique by which an automatic guided vehicle travels along a path indicated on a map while performing processing for recognizing the position of the vehicle itself by using a distance-measuring sensor such as a laser scanner is disclosed.

As described above, heretofore, a system of an automatic guided vehicle that travels by detecting an actual magnetic guide tape and a system of an automatic guided vehicle that travels in accordance with a map have independently existed.

### SUMMARY OF INVENTION

In the system of Japanese Laid-Open Patent Publication No. 08-234836, the vehicle only can travel on a path previously set by a magnetic guide sensor, and consequently it is impossible to perform flexible conveyance.

Meanwhile, in the system of Japanese Laid-Open Patent Publication No. 09-230933 and Japanese Laid-Open Patent Publication No. 10-149217, a map has to be prepared in advance, which makes it impossible to operate an automatic guided vehicle immediately by making use of a path of a magnetic guide tape. Moreover, in the system of Japanese Laid-Open Patent Publication No. 09-230933 and Japanese Laid-Open Patent Publication No. 10-149217, in an environment in which no fixed object exists around the automatic guided vehicle, the automatic guided vehicle cannot perform measurement of distance to thereby recognize the position thereof. Consequently, it is impossible to operate the automatic guided vehicle.

When a new system is constructed by adopting the advantage of the system of Japanese Laid-Open Patent Publication No. 08-234836 and the advantage of the system of Japanese Laid-Open Patent Publication No. 09-230933 and Japanese Laid-Open Patent Publication No. 10-149217, it is necessary to incorporate two types of systems into one automatic guided vehicle. This makes the automatic guided vehicle heavy, thick, long, and large, resulting in an increase in costs.

The present invention has been made in view of the above-described problems, and an object thereof is to provide an automatic guided vehicle that can travel in both an area where a guide tape is laid and an area where a guide tape is not laid.

An automatic guided vehicle according to the present invention is an automatic guided vehicle configured to travel along a guide tape which is actually laid. The automatic guided vehicle includes an actual guide sensor, a current position acquiring unit, a guide tape data storing unit, a virtual guide sensor processing unit, a guide sensor switching processing unit, and a position attitude calculating unit.

The actual guide sensor detects the guide tape and outputs the position of the detected guide tape. The current position acquiring unit acquires the current position of the automatic guided vehicle. The guide tape data storing unit stores data on a virtually set guide tape as guide tape data. The virtual guide sensor processing unit calculates the position of the virtual guide tape by using the current position and the guide tape data. The guide sensor switching processing unit switches between an output of the actual guide sensor and an output of the virtual guide sensor processing unit. The position attitude calculating unit calculates the position attitude of the automatic guided vehicle based on the position of the guide tape input via the guide sensor switching processing unit.

With this configuration, the guide sensor switching processing unit outputs, to the position attitude calculating unit, one of the position of the actual guide tape which the actual guide sensor has detected and the position of the virtual guide tape which the virtual guide sensor processing unit has calculated. As a result, since the position attitude calculating unit can calculate the position attitude of the automatic guided vehicle, it is possible to perform travel control of the automatic guided vehicle. That is, in the present invention, it is possible to receive the output of the actual guide sensor and the output of the virtual guide sensor processing unit with one system and process the output while switching between the two outputs.

Moreover, the current position acquiring unit acquires the current position of the automatic guided vehicle, and the virtual guide sensor processing unit calculates the position of the virtual guide tape by using this current position and the guide tape data. With this configuration, the virtual guide sensor processing unit has an output form which is substantially identical to an output form in a case in which the actual guide tape is used. That is, the virtual guide sensor processing unit can convert the output form to the output form which is obtained when the guide tape is used. As a result, the position attitude calculating unit can use both the position of the actual guide tape detected by the actual guide sensor and the position of the virtual guide tape calculated by the virtual guide sensor processing unit.

Therefore, in the present invention, it is possible to make the automatic guided vehicle travel in both an area where the guide tape is actually laid and an area where the guide tape is not laid. That is, in the area where the guide tape is actually laid, the automatic guided vehicle is made to travel along the guide tape; on the other hand, in the area where the guide tape is not laid, it is possible to make the automatic guided vehicle travel as if the guide tape were laid in that area. Furthermore, since the position of the guide tape is output from both the actual guide sensor and the virtual guide sensor processing unit, the automatic guided vehicle can implement travel on the guide tape and travel in the area where the guide tape is not present, with one system without greatly changing a portion related to travel control.

In addition, with the present invention, the following effects can also be obtained.

Even in an environment of the magnetic guide tape used in the existing automatic guided vehicle, the present invention can be immediately applied and operated.

Moreover, even in an environment where measurement of distance by a distance-measuring sensor is impossible, e.g., an environment without a reflecting wall or an environment in which the position attitudes of a person and a component change from moment to moment, operation of the automatic guided vehicle is possible by using other current position acquiring means that can acquire the current position in real time.

Furthermore, by using the acquired current position and the guide tape data, it is possible to perform operation with a flexible path in accordance with a situation. For example, it is possible to avoid an obstacle and also to, at the time of coupling to a workpiece, recognize the position attitude of the workpiece and perform the coupling.

In addition, since one travel control algorithm can support these functions, it is possible to configure a system of the automatic guided vehicle which is lighter, thinner, shorter, smaller, and low-cost. That is, heretofore, for implementing functions such as path calculation in order to avoid an obstacle and recognition of the position attitude of a workpiece, etc., it has been necessary to create control algorithms as different functions. By contrast, in the present invention, the guide tape data is output by using these functions and the automatic guided vehicle travels based on this data, whereby it is possible to implement the functions such as actual avoidance of an obstacle, coupling of a workpiece, etc.

Here, the current position acquiring unit may acquire a center position of the automatic guided vehicle as the current position, and the guide tape data may be line segment data including at least a starting point position, an end point position, and the width of the virtual guide tape. In this case, the virtual guide sensor processing unit may set the installation position of the actual guide sensor in the automatic guided vehicle as the position of a virtual guide sensor with reference to the current position and, by comparing the position of the virtual guide sensor and the guide tape data, determine whether or not the position of the virtual guide sensor lies within the range of the line segment data.

As described above, since the guide tape data is numerical data within a predetermined range, the memory capacity of the guide tape data storing unit can be made smaller. Moreover, by making the position of the virtual guide sensor coincide with the installation position of the actual guide sensor, and determining whether or not the position of the virtual guide sensor lies within the range of the line segment data, the accuracy with which the position of the virtual guide sensor is calculated by the virtual guide sensor processing unit is improved, and it is possible to obtain a calculation result similar to that obtained when the actual guide sensor detects the actual guide tape.

Moreover, a plurality of the actual guide sensors may be arranged along a vehicle-width direction at each of the front and the rear of the automatic guided vehicle. In this case, the virtual guide sensor processing unit may set the installation position of each actual guide sensor in the automatic guided vehicle as the position of the virtual guide sensor with reference to the current position and, by comparing the position of the virtual guide sensor and the guide tape data, determine whether or not the position of the virtual guide sensor lies within the range of the line segment data.

With the above configuration, it is possible for the position attitude calculating unit to highly accurately calculate the attitude of the automatic guided vehicle with respect to the virtual guide tape, based on the determination result of the virtual guide sensor processing unit input via the guide sensor switching processing unit.

Furthermore, in the present invention, a marker tape configured to make the automatic guided vehicle recognize the content of a command regarding travel of the automatic guided vehicle is disposed near the guide tape. In this case, the automatic guided vehicle further includes an actual marker sensor, a marker tape data storing unit, a virtual marker sensor processing unit, a marker sensor switching processing unit, and a job command execution processing unit.

The actual marker sensor detects the marker tape. The marker tape data storing unit stores data on a virtually set marker tape as marker tape data. The virtual marker sensor processing unit calculates the position of the virtual marker tape by using the current position and the marker tape data. The marker sensor switching processing unit switches between an output of the actual marker sensor and an output of the virtual marker sensor processing unit. The job command execution processing unit determines, based on the position of the marker tape input via the marker sensor switching processing unit, whether or not to end the current job command for the automatic guided vehicle and execute a next job command.

The marker tape is a marker for providing, to the automatic guided vehicle, instructions to complete the job command, start execution of a next job command, and so forth when the automatic guided vehicle travels along the guide tape, and functions as a trigger for making the automatic guided vehicle recognize start or end of execution of the job command. For example, the automatic guided vehicle is caused to recognize the travel commands such as “start”, “stop”, “turn”, and “accelerate/decelerate” for the automatic guided vehicle.

As described above, the marker tape is disposed near the guide tape. Therefore, in an area where the guide tape is not laid, the marker tape is not laid.

Thus, in the present invention, as in the case of the guide tape, the marker sensor switching processing unit outputs, to the job command execution processing unit, one of the detection result of the actual marker sensor and the calculation result of the virtual marker sensor processing unit. Owing thereto, in the case that the marker tape can be detected (if the position of the virtual marker tape can be calculated), the job command execution processing unit can execute a next job command. Also in this case, it is possible to receive the output of the actual marker sensor and the output of the virtual marker sensor processing unit with one system, and process the output while switching between the two outputs.

Moreover, the virtual marker sensor processing unit calculates the position of the virtual marker tape by using the current position of the automatic guided vehicle and the marker tape data. Owing thereto, the virtual marker sensor processing unit has an output form which is substantially identical to that in a case where the actual marker tape is used. As a result, the job command execution processing unit can use both the detection result of the actual marker sensor and the calculation result of the virtual marker sensor processing unit.

Therefore, in the present invention, it is possible to make the automatic guided vehicle travel and sequentially execute the job commands provided to the automatic guided vehicle, irrespective of the presence or absence of the guide tape and the marker tape.

Here, the marker tape data may be line segment data having a center position, an attitude, and the entire length and the width of the virtual marker tape. In this case, the virtual marker sensor processing unit sets the installation position of the actual marker sensor in the automatic guided vehicle as the position of a virtual marker sensor with reference to the current position and, by comparing the position of the virtual marker sensor and the marker tape data, determines whether or not the position of the virtual marker sensor lies within the range of the line segment data.

As described above, since the marker tape data is numerical data within a predetermined range, the memory capacity of the marker tape data storing unit can be made smaller. Furthermore, by making the position of the virtual marker sensor coincide with the installation position of the actual marker sensor and determining whether or not the position of the virtual marker sensor lies within the range of the line segment data, the accuracy of the position of the virtual marker sensor which is calculated by the virtual marker sensor processing unit is improved, and it is possible to obtain a calculation result which is similar to that obtained when the actual marker sensor detects the actual marker tape can be obtained.

Moreover, two actual marker sensors may be arranged on respective both sides in a vehicle-width direction at the front of the automatic guided vehicle. In this case, the virtual marker sensor processing unit sets each of the installation positions of the two actual marker sensors in the automatic guided vehicle as the position of the virtual marker sensor, which includes two virtual marker sensors, with reference to the current position and, by comparing the positions of the two virtual marker sensors and the marker tape data, determines whether or not each of the positions of the two virtual maker sensors lies within the range of the line segment data.

As a result, the job command execution processing unit can accurately determine the execution of a next job command based on the determination result of the virtual marker sensor processing unit input via the marker sensor switching processing unit.

### BRIEF DESCRIPTION OF DRAWINGS

FIG. 1 is a block diagram of an AGV according to an embodiment of the present invention;

FIG. 2 is a block diagram of a motion ECU of FIG. 1;

FIGS. 3A and 3B are explanatory diagrams schematically depicting a case in which the AGV travels on a magnetic guide tape (a virtual guide tape);

FIG. 4A is an explanatory diagram schematically illustrating a layout of magnetic guide sensors (virtual guide sensors) in the AGV, FIG. 4B is an explanatory diagram illustrating a detailed layout of the magnetic guide sensors, and FIG. 4C is an explanatory diagram schematically illustrating a layout of the magnetic guide sensors (virtual guide sensors) and magnetic marker sensors (virtual marker sensors) in the AGV;

FIG. 5 is an explanatory diagram schematically illustrating the attitude of the AGV with respect to the magnetic guide tape;

FIG. 6 is an explanatory diagram illustrating a case in which the AGV travels while avoiding an obstacle by using the virtual guide tape;

FIG. 7 is an explanatory diagram illustrating travel of the AGV when the magnetic guide tape and the magnetic marker tape are laid in a factory;

FIG. 8 is a diagram depicting an example of a program of a job command; and

FIG. 9A is an explanatory diagram depicting an example in which the magnetic guide tape is laid in the shape of a grid and FIG. 9B is an explanatory diagram depicting an example in which the magnetic guide tape is laid only at intersection points of a grid.

### DESCRIPTION OF EMBODIMENTS

Hereinafter, a preferred embodiment of an automatic guided vehicle according to the present invention will be illustrated and described with reference to the accompanying drawings.

### [Basic Configuration of Automatic Guided Vehicle 10]

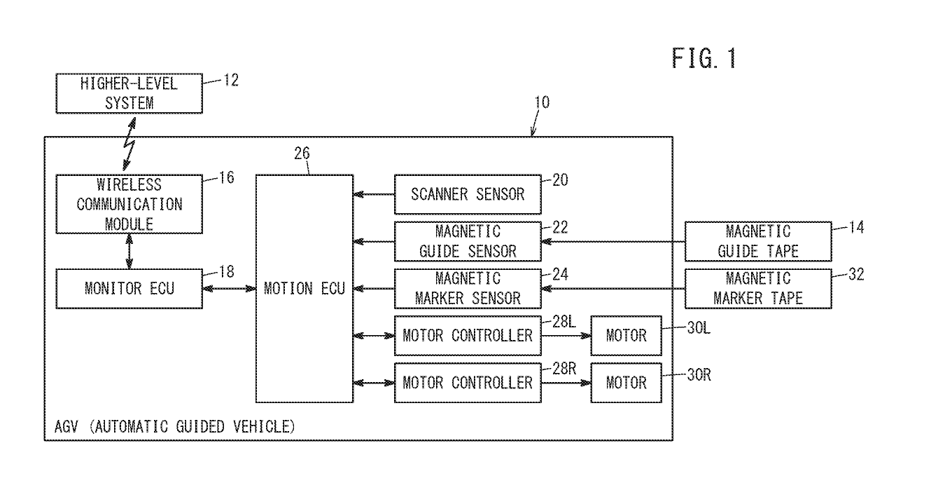

FIG. 1 is a block diagram of an automatic guided vehicle 10 according to an embodiment of the present invention. The automatic guided vehicle 10 is, for example, an unmanned conveying carriage (an unmanned conveyance vehicle), which is driven by a battery and supplies and conveys articles such as parts or components in a factory. In the following description, the automatic guided vehicle 10 is also referred to as AGV (Automatic Guided Vehicle) 10. The AGV 10 receives a job command (job data, an instruction signal) from a higher-level system 12 via wireless communication, and can travel along a magnetic guide tape 14 laid in the factory in accordance with the received job command.

The AGV 10 includes a wireless communication module 16 (a communication unit), a monitor ECU 18, a scanner sensor 20, a magnetic guide sensor 22 (an actual guide sensor), a magnetic marker sensor 24 (an actual marker sensor), a motion ECU 26, motor controllers 28L, 28R, and motors 30L, 30R.

The wireless communication module 16 sends and receives data to and from the higher-level system 12 via wireless communication. The monitor ECU 18 is a computer including a microcomputer, and has a central processing unit (CPU), a memory, and so forth. The monitor ECU 18 can implement the following functions by reading and executing a program recorded in the memory as a non-transitory recording medium. That is, the monitor ECU 18 controls units in the AGV 10, such as the motion ECU 26, in accordance with a command from the higher-level system 12. Moreover, the monitor ECU 18 notifies the higher-level system 12 of the traveling state of the AGV 10, the state of an unillustrated battery, and so forth, via the wireless communication module 16.

The scanner sensor 20 is a position sensor that detects the position of the automatic guided vehicle 10. As such a sensor, there are, for example, a distance-measuring sensor such as a laser scanner, a position sensor using a GPS or autonomous navigation, and a position sensor using simultaneous localization and mapping (SLAM). The magnetic guide sensor 22 detects the magnetic guide tape 14. The magnetic marker sensor 24 detects a magnetic marker tape 32 which is laid near the magnetic guide tape 14.

The motion ECU 26 is a computer including a microcomputer, and has a CPU, a memory, and so forth. The monitor ECU 18 can implement the following functions by reading and executing a program recorded in the memory as a non-transitory recording medium. That is, the motion ECU 26 basically calculates the position attitude of the AGV 10 with respect to the magnetic guide tape 14 based on the position of the AGV 10 detected by the scanner sensor 20 and the position of the magnetic guide tape 14 detected by the magnetic guide sensor 22 in accordance with a job command from the higher-level system 12. Moreover, the motion ECU 26 outputs, to the motor controllers 28L, 28R, control signals for controlling the motors 30L, 30R based on a command velocity indicated by the job command and the calculation result. If the magnetic marker sensor 24 detects the magnetic marker tape 32, the motion ECU 26 ends the current job command, and executes a next job command. The motor controllers 28L, 28R rotate left and right wheels of the AGV 10 by driving the motors 30L, 30R, respectively, provided on the left and right sides of the AGV 10, based on the control signals from the motion ECU 26, and make the AGV 10 travel at a desired velocity.

### [General Outline of Virtual Guide Tape Function]

Here, prior to the description of the motion ECU 26, a virtual guide tape function, which is a characteristic function of the present embodiment, will be briefly described.

As described earlier, the AGV 10 is an unmanned conveyance vehicle using the magnetic guide tape 14 as a traveling path. However, if an object or the like is temporarily disposed on the traveling path and thereby blocks up the traveling path, then a new magnetic guide tape 14 has to be disposed in order to temporarily evacuate the AGV 10 or in order to move the AGV to a site where the AGV 10 receives an object to be conveyed. Moreover, if the traveling path has a grid shape, the magnetic guide tape 14 has to be arranged for each grid, resulting in increased costs and increased man-hours.

In order to deal with the above, the present embodiment has a virtual guide tape function, which will be described later, and this function is mainly performed by the motion ECU 26. This function replaces the magnetic guide tape 14 which has to be temporarily disposed, with a virtual magnetic guide tape (a virtual guide tape) or places the magnetic guide tapes 14 only on portions corresponding to intersection points of a grid and adopting the virtual guide tapes on other portions, whereby the installation cost and the number of man-hours are reduced.

Moreover, this virtual guide tape function is characterized by being capable of using the same position attitude and the same wheel control of the AGV 10 in both a case in which the magnetic guide tape 14 is used and a case in which the virtual guide tape function is used.

Furthermore, in the virtual guide tape function, information on the position where the magnetic guide tape 14 is disposed is used as position information of the virtual guide tape (virtual guide tape layout data). In this case, the position information of the virtual guide tape is based on line segment data from a start position to a target position, and an area extending left and right a predetermined width from the center position of the line segment data is regarded as a virtual guide tape. Owing thereto, the memory capacity for storing the line segment data can be made smaller.

Meanwhile, as described above, the AGV 10 includes the magnetic guide sensor 22; however, when the virtual guide tape function is used, the AGV 10 does not use the magnetic guide sensor 22 but uses a virtual guide sensor. In this case, the AGV 10 acquires and recognizes the current position (the center position of the AGV 10) as a vehicle body coordinate value, and by using the center position as a reference, sets the position at which the actual magnetic guide sensor 22 is present as the position of the virtual guide sensor. Then, the AGV 10 compares the position of the virtual guide sensor and the virtual guide tape layout data. The AGV 10 outputs “1” if the position of the virtual guide sensor is within the range of the line segment data constituting the virtual guide tape layout data, and outputs “0” if the position of the virtual guide sensor is not within the above range. This makes it possible to obtain an output similar to an output that would be obtained when the actual magnetic guide sensor 22 senses the magnetic guide tape 14.

### [General Outline of Virtual Marker Tape Function]

Next, prior to the description of the motion ECU 26, a virtual marker tape function, which is another characteristic function of the present embodiment, will be briefly described.

When the AGV 10 travels on the magnetic guide tape 14, it is necessary to provide, to the AGV 10, instructions to complete the job command, start execution of a next job command, and so forth. For example, for the AGV 10, it is necessary to make the AGV 10 recognize travel commands such as “start”, “stop”, “turn”, and “accelerate/decelerate”. For this purpose, in the present embodiment, the magnetic marker tape 32 that functions as a trigger for making the AGV 10 recognize start or end of execution of a job command is disposed near the magnetic guide tape 14. Specifically, the magnetic marker tape 32 is disposed near the outside or inside of the magnetic guide tape 14 at a position where recognition of the travel command by the AGV 10 is needed.

Then, in the virtual marker tape function, a virtual magnetic marker tape (a virtual marker tape) is set along the above-described virtual guide tape in a position where recognition of the travel command by the AGV 10 is needed. The virtual marker tape is sensed by a virtual marker sensor. As in the case of the virtual guide sensor, the virtual marker sensor is set in the same position as the magnetic marker sensor 24 which is actually installed in the AGV 10. A virtual marker tape sensing method which is performed by the virtual marker sensor is similar to a virtual guide tape sensing method which is performed by the virtual guide sensor.

Then, when the traveling path is set by the magnetic guide tape 14, if an obstacle is placed on the traveling path only for a fixed period of time, the virtual guide tape and the virtual marker tape are set so that the AGV 10 avoids the obstacle.

Moreover, since the AGV 10 has the virtual guide tape function and the virtual marker tape function, the AGV 10 can select (1) a travel mode in which the AGV 10 travels on the magnetic guide tape 14, (2) a travel mode in which the AGV 10 travels on the virtual guide tape, (3) a travel mode in which the AGV 10 mainly travels on the magnetic guide tape 14 and temporarily travels on the virtual guide tape, and (4) a travel mode in which the AGV 10 mainly travels on the virtual guide tape and temporarily travels on the magnetic guide tape 14. These travel modes are set and executed by the motion ECU 26.

### [Configuration of Motion ECU 26]

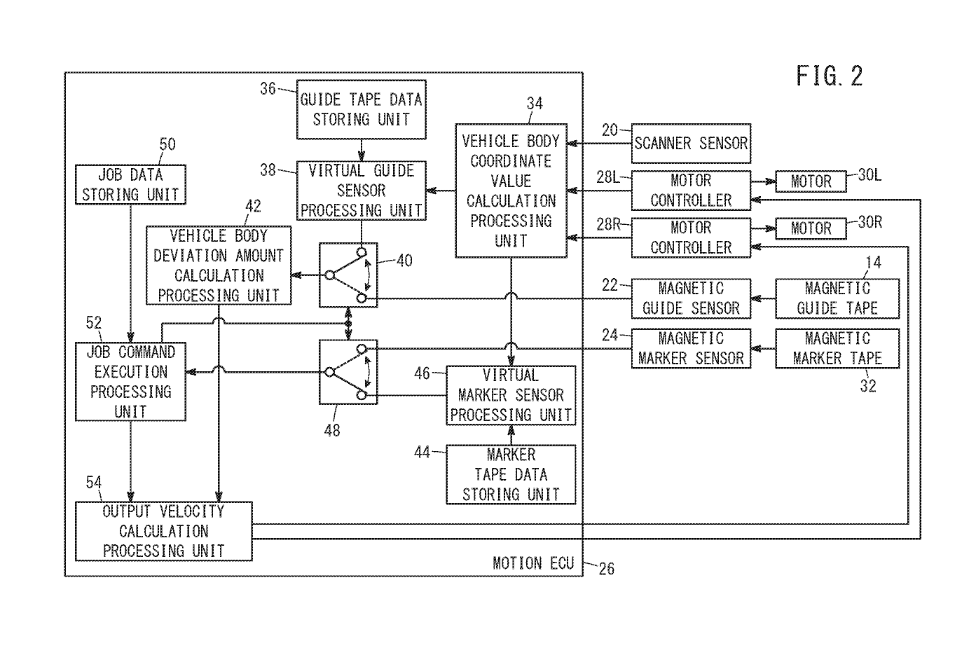

A specific configuration of the motion ECU 26 to implement the above-described characteristic functions (the virtual guide tape function and the virtual marker tape function) of the AGV 10 according to the present embodiment will be described with reference to FIG. 2 and other drawings.

FIG. 2 is a block diagram depicting the configuration of the motion ECU 26. The motion ECU 26 includes a vehicle body coordinate value calculation processing unit 34 (a current position acquiring unit), a guide tape data storing unit 36, a virtual guide sensor processing unit 38, a guide sensor switching processing unit 40, a vehicle body deviation amount calculation processing unit 42 (a position attitude calculating unit), a marker tape data storing unit 44, a virtual marker sensor processing unit 46, a marker sensor switching processing unit 48, a job data storing unit 50, a job command execution processing unit 52, and an output velocity calculation processing unit 54.

The vehicle body coordinate value calculation processing unit 34 acquires the current position of the AGV 10 by calculating the vehicle body coordinate value of the AGV 10 based on the detection result of the scanner sensor 20 (the position information of the AGV 10), the rotational speeds of the left and right wheels from the motor controllers 28L, 28R, and so forth.

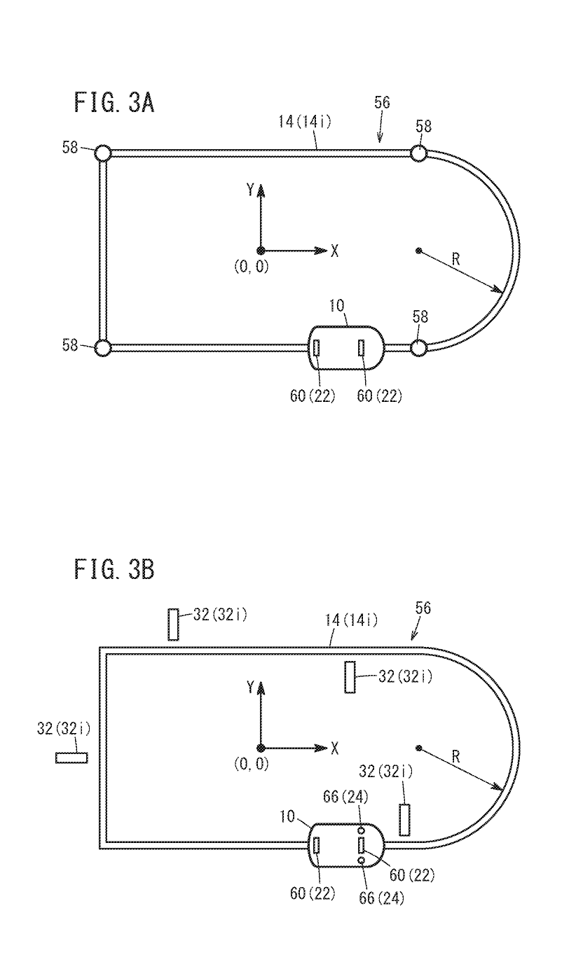

In the guide tape data storing unit 36, regarding an area where the magnetic guide tape 14 is not laid, data on a virtually set magnetic guide tape (a virtual guide tape 14i in FIGS. 3A and 3B) is stored as virtual guide tape layout data (guide tape data).

Here, the magnetic guide tape 14 will be described in detail with reference to FIG. 3A. FIG. 3A illustrates an example of a traveling path 56 of the AGV 10 on which the magnetic guide tape 14 is laid. The traveling path 56 is formed by combining a plurality of straight lines and circular arcs (hereinafter also referred to as line segments). Here, a point 58 on the traveling path 56 indicates the position of the starting point or the end point of each line segment. The traveling path 56 of FIG. 3A may be a traveling path formed of the virtual guide tape 14i in place of the magnetic guide tape 14.

Then, for the traveling path 56 of FIG. 3A, numerical data of the following items is stored in advance in the guide tape data storing unit 36 as the virtual guide tape layout data. The items are: (1) the number of each of line segments forming the traveling path 56; (2) the type (a straight line or a circular arc) of the shape of each line segment; (3) the starting point position of each line segment; (4) the end point position of each line segment; (5) the width of the virtual guide tape 14i (the width in a left and right direction with respect to the center position of the virtual guide tape 14i); and (6) the radius of a circular arc if the line segment is a circular arc.

Meanwhile, as depicted in FIG. 3B, the magnetic marker tapes 32 are laid near the magnetic guide tape 14. The magnetic marker tape 32 is a linear tape which is placed on a side of the magnetic guide tape 14, and as described above, is a mark for making the AGV 10 recognize the travel commands such as “start”, “stop”, “turn”, and “accelerate/decelerate”, etc., when the AGV 10 travels along the magnetic guide tape 14. Therefore, by detecting the magnetic marker tape 32, the AGV 10 can execute the travel command indicated by the magnetic marker tape 32. In an area where the magnetic guide tape 14 is not laid, the magnetic marker tape 32 is not laid.

Thus, in the marker tape data storing unit 44, for an area where the magnetic marker tape 32 is not laid, data on a virtually set magnetic marker tape (a virtual marker tape 32i) is stored as virtual marker tape layout data (marker tape data). Therefore, when the traveling path 56 is formed of the virtual guide tape 14i, the virtual marker tape 32i is set in place of the magnetic marker tape 32.

Therefore, for the traveling path 56 of FIG. 3B, numerical data of the following items is stored in advance in the marker tape data storing unit 44 as the virtual marker tape layout data. The items are: (1) the number of each of the virtual marker tapes 32i, (2) the center position of each virtual marker tape 32i, (3) the attitude of each virtual marker tape 32i, (4) the entire length of each virtual marker tape 32i, and (5) the width of each virtual marker tape 32i.

The virtual guide sensor processing unit 38 calculates, for an area where no magnetic guide tape 14 is actually laid, the position of the virtual guide tape 14i by using the vehicle body coordinate value of the AGV 10 calculated by the vehicle body coordinate value calculation processing unit 34 and the virtual guide tape layout data. That is, in the area where the magnetic guide tape 14 is not laid, the virtual guide sensor processing unit 38 functions as a virtual magnetic guide sensor (a virtual guide sensor) in place of the actual magnetic guide sensor 22.

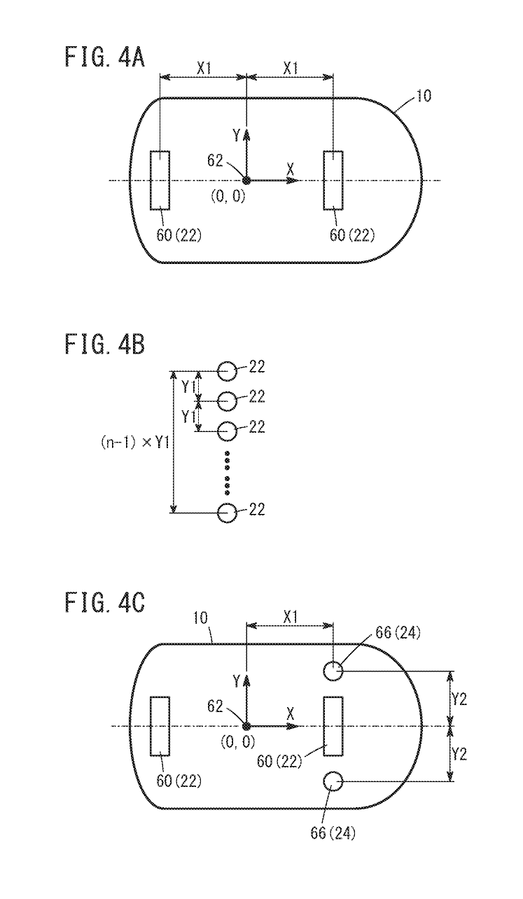

Here, the relationship between the actual magnetic guide sensor 22 and a virtual guide sensor 60 will be described with reference to FIGS. 4A and 4B.

FIG. 4A is an explanatory diagram illustrating the installation positions of the virtual guide sensors 60 in the AGV 10. The virtual guide sensor 60 is disposed at each of positions that are located an equal distance X1 away from a center position 62 of the AGV 10 in the front-back direction (X direction) of a vehicle body. This position is also a position in which a plurality of magnetic guide sensors 22 are arranged at equal intervals Y1 in the vehicle-width direction (Y direction) as depicted in FIG. 4B. That is, the virtual guide sensor 60 sets the installation position of the magnetic guide sensors 22 in the AGV 10 as the position of the virtual guide sensor 60 with reference to the current position (the center position 62) of the AGV 10. In FIG. 4A and the subsequent drawings, the installation position of the virtual guide sensor 60 and the magnetic guide sensors 22 is, in some cases, schematically depicted as a rectangle as in FIG. 4A.

Here, assuming that the number of the plurality of magnetic guide sensors 22 which are arranged in the vehicle-width direction at the front or rear of the vehicle body is n, and the arrangement interval of the magnetic guide sensors 22 is Y1, the entire length of the virtual guide sensor 60 in the vehicle-width direction is expressed by (n−1)×Y1. Moreover, since one virtual guide sensor 60 corresponds to n magnetic guide sensors 22, the resolution of the virtual guide sensor 60 is n.

Therefore, the virtual guide sensor processing unit 38 sets the installation position of the magnetic guide sensors 22 in the AGV 10 as the position of the virtual guide sensor 60 with reference to the current center position 62 of the AGV 10, and compares the position of the virtual guide sensor 60 and data of each line segment (line segment data indicating the virtual guide tape 14i) in the virtual guide tape layout data. In this comparison, the virtual guide sensor processing unit 38 determines whether or not the position of the virtual guide sensor 60 lies within the range indicated by the line segment data, that is, whether or not there is an overlap between the virtual guide sensor 60 and a straight line or a circular arc indicated by the line segment data.

As described above, since the plurality of magnetic guide sensors 22 are replaced with one virtual guide sensor 60, for each installation position of the magnetic guide sensors 22, the virtual guide sensor processing unit 38 determines the result to be “1” (ON) if there is an overlap with the straight line or the circular arc, and determines the result to be “0” (OFF) if there is no overlap. Moreover, since the virtual guide sensor 60 is disposed at each of the front and the rear of the AGV 10, the virtual guide sensor processing unit 38 makes such an overlap determination for each of the front and rear virtual guide sensors 60. That is, the virtual guide sensor processing unit 38 judges whether or not the schematic rectangles indicating the installation positions of the front and rear virtual guide sensors 60 intersect the line segment of the virtual guide tape 14i.

Then, the virtual guide sensor processing unit 38 outputs the determination result including the position of the virtual guide tape 14i (the installation position of the magnetic guide sensor 22 for which it has been determined that there is an overlap) to the guide sensor switching processing unit 40.

The guide sensor switching processing unit 40 outputs, to the vehicle body deviation amount calculation processing unit 42, one of the determination result (the position of the virtual guide tape 14i) from the virtual guide sensor processing unit 38 and the position of the magnetic guide tape 14 which the magnetic guide sensor 22 has actually detected.

In this case, for example, when the AGV 10 is actually traveling on the magnetic guide tape 14 or when the travel mode on the virtual guide tape 14i is switched to the travel mode of the actual magnetic guide tape 14, the guide sensor switching processing unit 40 outputs, to the vehicle body deviation amount calculation processing unit 42, the position of the magnetic guide tape 14 which the magnetic guide sensor 22 has detected.

On the other hand, when the AGV 10 is traveling on the virtual guide tape 14i or when the travel mode of the actual magnetic guide tape 14 is switched to the travel mode on the virtual guide tape 14i, the guide sensor switching processing unit 40 outputs, to the vehicle body deviation amount calculation processing unit 42, the position of the virtual guide tape 14i which the virtual guide sensor processing unit 38 has calculated.

The guide sensor switching processing unit 40 only has to switch the position to be output to the vehicle body deviation amount calculation processing unit 42 in accordance with the instruction from the job command execution processing unit 52.

Moreover, as described earlier, the position of the actual magnetic guide tape 14 is detected by the plurality of magnetic guide sensors 22. Thus, when outputting the detection result of the magnetic guide sensor 22 to the vehicle body deviation amount calculation processing unit 42, the guide sensor switching processing unit 40 only has to output the detection results of the plurality of magnetic guide sensors 22 to the vehicle body deviation amount calculation processing unit 42. In this case, since the magnetic guide sensors 22 are arranged in the vehicle-width direction (Y direction) at the front and rear of the AGV 10, the magnetic guide sensor 22 that has detected the magnetic guide tape 14 outputs a detection signal “1” (ON); on the other hand, the magnetic guide sensor 22 that could not detect the magnetic guide tape 14 outputs a detection signal “0” (OFF).

The vehicle body deviation amount calculation processing unit 42 calculates the position attitude of the AGV 10 based on the position of the actual magnetic guide tape 14 or the position of the virtual guide tape 14i, which has been input via the guide sensor switching processing unit 40. In this case, the vehicle body deviation amount calculation processing unit 42 calculates the degree of deviation of the vehicle body of the AGV 10 with respect to the magnetic guide tape 14 or the virtual guide tape 14i from the determination result (the state “1” or “0”) of the virtual guide sensor 60 or the detection result (the detection signal “1” or “0”) of each magnetic guide sensor 22.

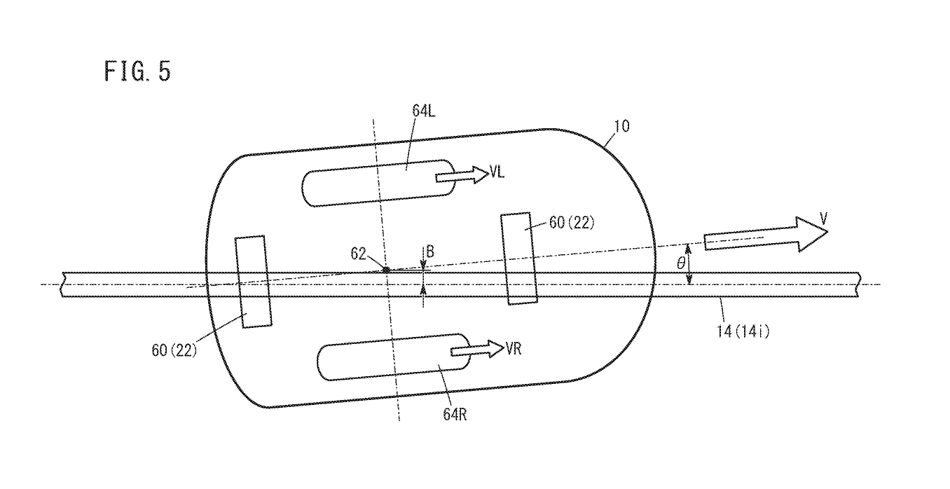

FIG. 5 is an explanatory diagram schematically illustrating the attitude of the AGV 10 with respect to the magnetic guide tape 14 or the virtual guide tape 14i. The vehicle body deviation amount calculation processing unit 42 determines the attitude angle θ of the vehicle body with respect to the magnetic guide tape 14 (the virtual guide tape 14i) and determines the distance B between the center position of the magnetic guide tape 14 (the virtual guide tape 14i) and the center position 62 of the vehicle body.

Meanwhile, regarding an area where no magnetic marker tape 32 is actually laid, the virtual marker sensor processing unit 46 calculates the position of the virtual marker tape 32i by using the current center position 62 of the AGV 10 which the vehicle body coordinate value calculation processing unit 34 has calculated and the virtual marker tape layout data. That is, the virtual marker sensor processing unit 46 functions as a virtual magnetic marker sensor (a virtual marker sensor), in place of the actual magnetic marker sensor 24, even in an area where the magnetic marker tape 32 is not laid.

Here, the relationship between the actual magnetic marker sensor 24 and a virtual marker sensor 66 will be described with reference to FIG. 4C.

FIG. 4C is an explanatory diagram illustrating the installation positions of the virtual guide sensor 60 and the virtual marker sensor 66 in the AGV 10. The virtual marker sensor 66 is disposed at each of positions (i.e., the positions on the left and right sides of a center line (indicated by the alternate long and short dashed line) passing through the center position 62, the positions being a distance Y2 away from the center line in the vehicle-width direction) of both ends of the virtual guide sensor 60 on the front direction (the X direction) side of the vehicle body with respect to the center position 62 of the AGV 10. This position is a position in which the actual magnetic marker sensor 24 is placed. That is, the virtual marker sensor 66 sets the installation position of the magnetic marker sensor 24 in the AGV 10 as the position of the virtual marker sensor 66 with reference to the current position (the center position 62) of the AGV 10.

Therefore, the virtual marker sensor processing unit 46 sets the installation position of the magnetic marker sensor 24 in the AGV 10 as the position of the virtual marker sensor 66 with reference to the current center position 62 of the AGV 10, and compares the position of the virtual marker sensor 66 and the virtual marker tape layout data (line segment data indicating the virtual marker tape 32i). In this comparison, the virtual marker sensor processing unit 46 determines whether or not the position of the virtual marker sensor 66 lies within the range of the line segment data, that is, whether or not there is an overlap between the virtual marker sensor 66 and the line segment data.

As described earlier, since each of the two magnetic marker sensors 24 is replaced with the virtual marker sensor 66, for each installation position of the magnetic marker sensor 24, the virtual marker sensor processing unit 46 determines the result to be “1” (ON) if there is an overlap with the line segment data, and determines the result to be “0” (OFF) if there is no overlap. This makes it possible for the virtual marker sensor processing unit 46 to determine whether or not a schematic circle indicating the installation position of the virtual marker sensor 66 is included in the line segment of the virtual marker tape 32i.

Then, the virtual marker sensor processing unit 46 outputs the determination result including the position of the virtual marker tape 32i (the installation position of the magnetic marker sensor 24 for which it has been determined that there is an overlap) to the marker sensor switching processing unit 48.

The marker sensor switching processing unit 48 outputs, to the job command execution processing unit 52, one of the determination result (the position of the virtual marker tape 32i) from the virtual marker sensor processing unit 46 and the position of the magnetic marker tape 32 which the magnetic marker sensor 24 has actually detected.

In this case, for example, when the AGV 10 is actually traveling on the magnetic guide tape 14 or when the travel mode on the virtual guide tape 14i is switched to the travel mode of the actual magnetic guide tape 14, the marker sensor switching processing unit 48 outputs, to the job command execution processing unit 52, the position of the magnetic marker tape 32 which the magnetic marker sensor 24 has detected.

On the other hand, when the AGV 10 is traveling on the virtual guide tape 14i or when the travel mode of the actual magnetic guide tape 14 is switched to the travel mode on the virtual guide tape 14i, the marker sensor switching processing unit 48 outputs, to the job command execution processing unit 52, the position of the virtual marker tape 32i which the virtual marker sensor processing unit 46 has calculated.

The marker sensor switching processing unit 48 only has to switch the position to be output to the job command execution processing unit 52 in accordance with the instruction from the job command execution processing unit 52.

In the job data storing unit 50, the job command received from the higher-level system 12 is stored.

The job command execution processing unit 52 reads the job command from the job data storing unit 50, and outputs a command velocity in accordance with the job command to the output velocity calculation processing unit 54. Moreover, the job command execution processing unit 52 ends the current job command if the magnetic marker sensor 24 or the virtual marker sensor processing unit 46 detects the magnetic marker tape 32 based on the position of the magnetic marker tape 32 input via the marker sensor switching processing unit 48. Then, the job command execution processing unit 52 reads a new job command from the job data storing unit 50 to execute a next job command.

In this case, if “1” (ON) is input from the marker sensor switching processing unit 48, the job command execution processing unit 52 determines that the magnetic marker sensor 24 or the virtual marker sensor processing unit 46 has detected the magnetic marker tape 32. As described earlier, the magnetic marker tape 32 is a mark for making the AGV 10 recognize the travel commands such as “start”, “stop”, “turn”, and “accelerate/decelerate”. Thus, the job command execution processing unit 52 can determine that the current job command in the AGV 10 has been completed if the magnetic marker tape 32 is detected.

The output velocity calculation processing unit 54 calculates the velocity VL of a left wheel 64L and the velocity VR of a right wheel 64R based on the command velocity in accordance with the job command from the job command execution processing unit 52 and the degree of deviation (the distance B, the attitude angle θ) of the vehicle body of the AGV 10 with respect to the magnetic guide tape 14 calculated by the vehicle body deviation amount calculation processing unit 42.

Then, the output velocity calculation processing unit 54 supplies the control signal in accordance with the velocity VL to the motor controller 28L and also supplies the control signal in accordance with the velocity VR to the motor controller 28R. In response thereto, the motor controller 28L drives the motor 30L in accordance with the control signal, and the motor controller 28R drives the motor 30R in accordance with the control signal. As a result, the wheel 64L on the left side of the AGV 10 travels at the velocity VL, and the wheel 64R on the right side travels at the velocity VR. [Application Examples of the Present Embodiment]

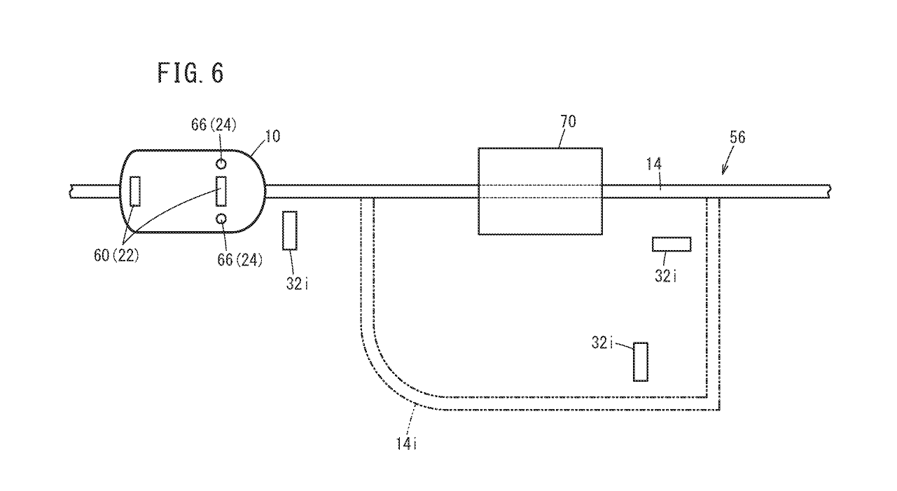

Application examples (first to fourth application examples) of the AGV 10 according to the present embodiment configured as described above will be described with reference to FIGS. 6 to 9B.

The first application example of FIG. 6 illustrates a case in which an obstacle 70 is present on the magnetic guide tape 14 in a factory. In this case, the AGV 10 can travel while avoiding the obstacle 70 by using the function of the virtual guide tape 14i.

Specifically, on the magnetic guide tape 14, the virtual guide tape 14i branches off from the magnetic guide tape 14 short of the obstacle 70. The virtual guide tape 14i bypasses the obstacle 70 and merges into the magnetic guide tape 14 in front of the obstacle 70. In this case, the virtual marker tape 32i is provided (1) before a branch point of the magnetic guide tape 14 and the virtual guide tape 14i, (2) before a point at which the line segment forming the virtual marker tape 32i bends at a right angle, and (3) before a merging point of the magnetic guide tape 14 and the virtual guide tape 14i.

As a result, when the AGV 10 travels on the magnetic guide tape 14, if the virtual marker sensor 66 detects the virtual marker tape 32i, the job command execution processing unit 52 controls the inside of the motion ECU 26 so that the travel mode of the magnetic guide tape 14 is switched to the travel mode of the virtual guide tape 14i. Specifically, the job command execution processing unit 52 ends the current job command, and reads a next job command from the job data storing unit 50 and executes the job command. Moreover, the job command execution processing unit 52 controls the guide sensor switching processing unit 40 so as to output the calculation result of the virtual guide sensor processing unit 38 to the vehicle body deviation amount calculation processing unit 42, and controls the marker sensor switching processing unit 48 so as to output the calculation result of the virtual marker sensor processing unit 46 to the job command execution processing unit 52.

As a result, the AGV 10 can travel on the virtual guide tape 14i from the branch point, which is located before the obstacle 70, of the magnetic guide tape 14 and the virtual marker tape 32i.

Then, if the virtual marker sensor 66 detects the third virtual marker tape 32i while the AGV 10 is traveling on the virtual marker tape 32i, the job command execution processing unit 52 controls the inside of the motion ECU 26 so that the travel mode of the virtual guide tape 14i is switched to the travel mode of the magnetic guide tape 14.

Specifically, the job command execution processing unit 52 ends the current job command, and reads a next job command from the job data storing unit 50 and executes the job command. Moreover, the job command execution processing unit 52 controls the guide sensor switching processing unit 40 so as to output the detection result of the magnetic guide sensor 22 to the vehicle body deviation amount calculation processing unit 42 and controls the marker sensor switching processing unit 48 so as to output the detection result of the magnetic marker sensor 24 to the job command execution processing unit 52.

As a result, the AGV 10 can travel on the magnetic guide tape 14 from the merging point, which is located in front of the obstacle 70, of the magnetic guide tape 14 and the virtual marker tape 32i.

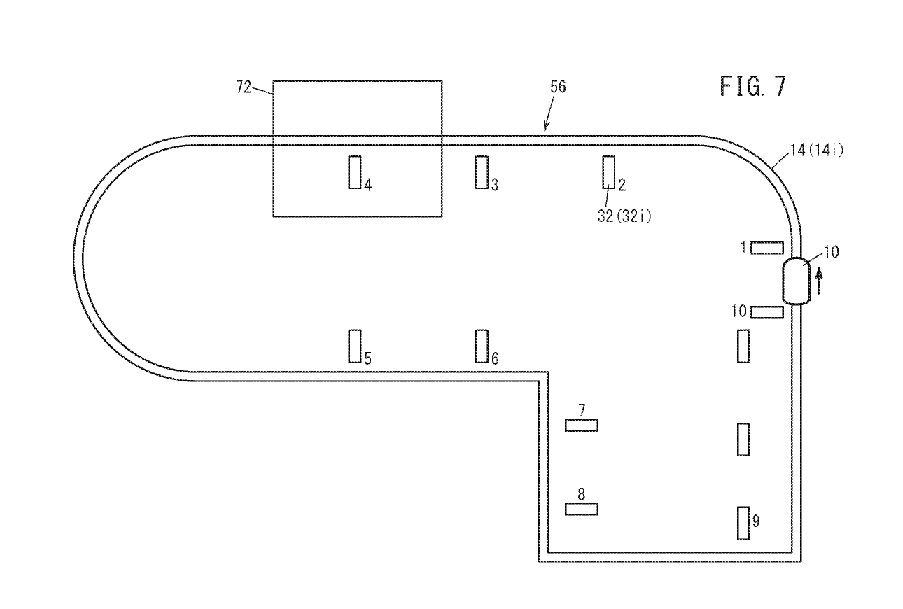

The second application example of FIG. 7 illustrates a case in which the magnetic guide tape 14 (the virtual guide tape 14i) and the magnetic marker tape 32 (the virtual marker tape 32i) are set in the factory. Therefore, the AGV 10 travels on the traveling path 56 of the magnetic guide tape 14 (the virtual guide tape 14i). On the traveling path 56, predetermined equipment 72 is present.

In this case, every time the AGV 10 detects the magnetic marker tape 32 (the virtual marker tape 32i) or when a predetermined condition of the job command is met, the AGV 10 can execute a next job command and travel. Moreover, when the magnetic marker tapes 32 (the virtual marker tapes 32i) are set on the right and left sides in the direction of travel, the job command can be set in advance so that the AGV 10 detects the magnetic marker tape 32 on one of the right and left sides. Furthermore, regarding the magnetic marker tape 32 (the virtual marker tape 32i) whose coordinate values are known, the current position (center position 62) of the AGV 10 may be updated when detecting that magnetic marker tape 32 (virtual marker tape 32i).

As described earlier, the magnetic marker tape 32 and the virtual marker tape 32i function as a trigger for making the AGV 10 recognize the travel commands such as “start”, “stop”, “turn”, and “accelerate/decelerate”; however, even if the AGV 10 can recognize “stop”, for example, the AGV 10 does not always stop immediately. Thus, it is also possible to place the magnetic marker tape 32 (the virtual marker tape 32i) before a spin turn or stopped position, and set this marker so as to indicate “stop A [mm] away”, for example.

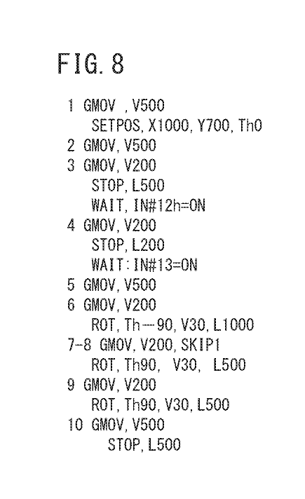

Moreover, in FIG. 7, numerical characters 1 to 10 beside the virtual marker tapes 32i are the numbers of the job commands and the virtual marker tapes 32i, and an example of programs of the job commands is depicted in FIG. 8.

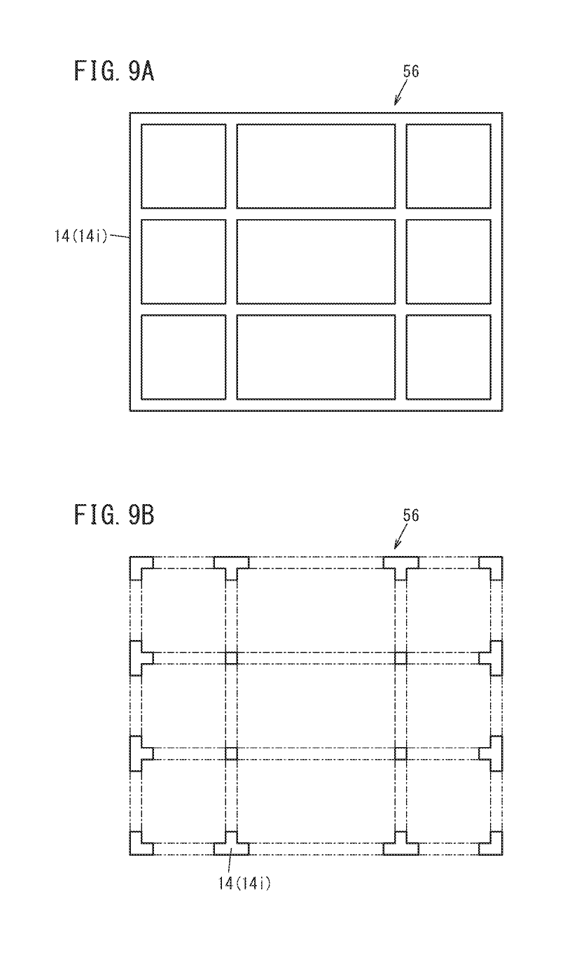

The third application example of FIG. 9A illustrates a case in which a specific plane is divided in a grid pattern and the magnetic guide tape 14 or the virtual guide tape 14i is set on all the grid sides. In this case, the AGV 10 travels along the grid sides.

The fourth application example of FIG. 9B illustrates a case in which the magnetic guide tapes 14 or the virtual guide tapes 14i having a square shape, a L shape, a T shape, and a cross shape are set only at the intersection points of the grid. In this case, the AGV 10 can travel along the magnetic guide tape 14 or the virtual guide tape 14i at the intersection points and travel along the virtual guide tape 14i between the points of intersection.

### [Effects of the Present Embodiment]

In the AGV 10 according to the present embodiment, the guide sensor switching processing unit 40 outputs, to the vehicle body deviation amount calculation processing unit 42, one of the position of the actual magnetic guide tape 14 which the magnetic guide sensor 22 has detected or the position of the virtual guide tape 14i which the virtual guide sensor processing unit 38 has calculated. As a result, since the vehicle body deviation amount calculation processing unit 42 can calculate the position attitude of the AGV 10, it is possible to control travel of the AGV 10. That is, in the present embodiment, it is possible to receive the output of the magnetic guide sensor 22 and the output of the virtual guide sensor processing unit 38 with one system and switch between the two outputs for processing.

Moreover, the vehicle body coordinate value calculation processing unit 34 acquires the current position of the AGV 10, and the virtual guide sensor processing unit 38 calculates the position of the virtual guide tape 14i by using this current position and the virtual guide tape layout data. As a result, the virtual guide sensor processing unit 38 has an output form which is substantially equal to that in the case in which the magnetic guide tape 14 is used. That is, the virtual guide sensor processing unit 38 can convert the output form into the output form which is obtained when the magnetic guide tape 14 is used. As a result, the vehicle body deviation amount calculation processing unit 42 can use both the position of the magnetic guide tape 14 which the magnetic guide sensor 22 has detected and the position of the virtual guide tape 14i which the virtual guide sensor processing unit 38 has calculated.

Therefore, in the present embodiment, it is possible to make the AGV 10 travel in both an area where the magnetic guide tape 14 is actually laid and an area where the magnetic guide tape 14 is not laid. That is, in the area where the magnetic guide tape 14 is actually laid, the AGV 10 is made to travel along the magnetic guide tape 14, whereas in the area where the magnetic guide tape 14 is not laid, it is possible to make the AGV 10 travel as if the magnetic guide tape 14 were laid in that area.

In addition, since the position of the magnetic guide tape 14 (the virtual guide tape 14i) is output from both the magnetic guide sensor 22 and the virtual guide sensor processing unit 38, the AGV 10 can implement both travel on the magnetic guide tape 14 and travel in the area where the magnetic guide tape 14 is not present, with one system without greatly changing a portion related to travel control.

By doing so, in the present embodiment, it is possible to perform travel control of the AGV 10 so that the magnetic guide sensor 22 or the virtual guide sensor 60 may not deviate from the magnetic guide tape 14 or the virtual guide tape 14i.

Furthermore, the present embodiment can obtain the following effects.

Even in an environment of the magnetic guide tape 14 used in the existing AGV, the present embodiment can be immediately applied and operated.

Moreover, even in an environment where measurement of distance by a distance-measuring sensor is impossible, e.g., an environment without a reflecting wall or an environment in which the position attitudes of a person and a component change from moment to moment, operation is possible by using other current position acquiring means that can acquire the current position in real time.

Furthermore, by using the acquired current position and the virtual guide tape layout data, it is possible to perform operation with a flexible path in accordance with a situation. For example, it is possible to avoid the obstacle 70 and also to, at the time of coupling to a workpiece, recognize the position attitude of the workpiece and perform the coupling.

In addition, since one travel control algorithm can support these functions, it is possible to configure a system of the AGV 10 which is lighter, thinner, shorter, smaller, and low-cost. That is, heretofore, for implementing functions such as path calculation in order to avoid the obstacle 70, recognition of the position attitude of a workpiece, etc., it has been necessary to create control algorithms as different functions. By contrast, in the present embodiment, the virtual guide tape layout data is output by using these functions, and the AGV 10 travels based on the data in accordance with the virtual guide tape function, whereby it is possible to implement the functions such as actual avoidance of the obstacle 70, coupling of a workpiece, etc.

Since the virtual guide tape layout data is numerical data within a predetermined range, the memory capacity of the guide tape data storing unit 36 can be made smaller. Moreover, by making the position of the virtual guide sensor 60 coincide with the installation position of the magnetic guide sensor 22 and determining whether or not the position of the virtual guide sensor 60 lies within the range of the line segment data, the accuracy of the position of the virtual guide sensor 60 which is calculated by the virtual guide sensor processing unit 38 is improved, and it is possible to obtain a calculation result similar to that obtained when the magnetic guide sensor 22 detects the actual magnetic guide tape 14.

Moreover, the plurality of magnetic guide sensors 22 are arranged at the front and rear of the AGV 10 and along the vehicle-width direction, and the virtual guide sensor processing unit 38 sets each of the installation positions of the magnetic guide sensors 22 in the AGV 10 as the position of the virtual guide sensor 60 with reference to the current position. Then, by comparing the position of the virtual guide sensor 60 and the virtual guide tape layout data, it is determined whether or not the position of the virtual guide sensor lies within the range of the line segment data. This makes it possible for the vehicle body deviation amount calculation processing unit 42 to calculate the attitude of the AGV 10 with respect to the virtual guide tape 14i with high accuracy based on the determination result of the virtual guide sensor processing unit 38 input via the guide sensor switching processing unit 40.

Meanwhile, the magnetic marker tape 32 is a marker for providing, to the AGV 10, instructions to complete the job command, start execution of a next job command, and so forth when the AGV 10 travels along the magnetic guide tape 14, and functions as a trigger for making the AGV 10 recognize start or end of execution of the job command. For example, the AGV 10 is caused to recognize the travel commands such as “start”, “stop”, “turn”, and “accelerate/decelerate” of the AGV 10.

As described earlier, the magnetic marker tape 32 is disposed near the magnetic guide tape 14. Therefore, in an area where the magnetic guide tape 14 is not laid, the magnetic marker tape 32 is not laid.

Thus, in the present embodiment, as in the case of the magnetic guide tape 14, the marker sensor switching processing unit 48 outputs one of the detection result of the magnetic marker sensor 24 and the calculation result of the virtual marker sensor processing unit 46 to the job command execution processing unit 52. Owing thereto, the job command execution processing unit 52 executes a next job command in the case that the magnetic marker tape 32 can be detected (the position of the virtual marker tape 32i can be calculated). Also in this case, it is possible to receive the output of the magnetic marker sensor 24 and the output of the virtual marker sensor processing unit 46 with one system, and switch between the two outputs for processing.

Moreover, the virtual marker sensor processing unit 46 calculates the position of the virtual marker tape 32i by using the current position of the AGV 10 and the virtual marker tape layout data. Owing thereto, the virtual marker sensor processing unit 46 has an output form which is substantially identical to that in a case where the actual magnetic marker tape 32 is used. As a result, the job command execution processing unit 52 can use both the detection result of the magnetic marker sensor 24 and the calculation result of the virtual marker sensor processing unit 46.

Therefore, in the present embodiment, it is possible to make the AGV 10 travel and sequentially execute the job commands provided to the AGV 10, irrespective of the presence or absence of the magnetic guide tape 14 and the magnetic marker tape 32.

Moreover, since the virtual marker tape layout data is numerical data within a predetermined range, the memory capacity of the marker tape data storing unit 44 can be made smaller. Furthermore, by making the position of the virtual marker sensor 66 coincide with the installation position of the magnetic marker sensor 24 and determining whether or not the position of the virtual marker sensor 66 is within the range of the line segment data, the accuracy with which the position of the virtual marker sensor 66 is calculated by the virtual marker sensor processing unit 46 is improved, and it is possible to obtain a calculation result which is similar to that obtained when the magnetic marker sensor 24 detects the actual magnetic marker tape 32.

In addition, the two magnetic marker sensors 24 are arranged on both sides in the vehicle-width direction at the front of the AGV 10, and the virtual marker sensor processing unit 46 sets the installation positions of the two magnetic marker sensors 24 in the AGV 10 as the positions of the two virtual marker sensors 66 with respect to the current position. Then, by comparing the positions of the two virtual marker sensors 66 and the virtual marker tape layout data, it is determined whether or not each position lies within the range of the line segment data. This makes it possible for the job command execution processing unit 52 to make an accurate determination of execution of a next job command based on the determination result of the virtual marker sensor processing unit 46 input via the marker sensor switching processing unit 48.

The present invention is not limited to the above-described embodiment, and it goes without saying that various configurations can be adopted within the scope of the present invention.

What is claim is:

1. An automatic guided vehicle configured to travel along a guide tape which is actually laid, the automatic guided vehicle comprising:
an actual guide sensor configured to detect the guide tape and output a position of the detected guide tape;
a current position acquiring unit configured to acquire a current position of the automatic guided vehicle;
a guide tape data storing unit configured to store data on a virtually set guide tape as guide tape data;
a virtual guide sensor processing unit configured to calculate a position of the virtual guide tape by using the current position and the guide tape data;
a guide sensor switching processing unit configured to switch between an output of the actual guide sensor and an output of the virtual guide sensor processing unit; and
a position attitude calculating unit configured to calculate a position attitude of the automatic guided vehicle based on the position of the guide tape input via the guide sensor switching processing unit.

2. The automatic guided vehicle according to claim 1, wherein
the current position acquiring unit acquires a center position of the automatic guided vehicle as the current position,
the guide tape data is line segment data including at least a starting point position, an end point position, and a width of the virtual guide tape, and
the virtual guide sensor processing unit
sets an installation position of the actual guide sensor in the automatic guided vehicle as a position of a virtual guide sensor with reference to the current position, and
by comparing the position of the virtual guide sensor and the guide tape data, determines whether or not the position of the virtual guide sensor lies within a range of the line segment data.

3. The automatic guided vehicle according to claim 2, wherein
the actual guide sensor comprises a plurality of actual guide sensors that are arranged along a vehicle-width direction at each of a front and a rear of the automatic guided vehicle, and
the virtual guide sensor processing unit
sets an installation position of each of the actual guide sensors in the automatic guided vehicle as the position of the virtual guide sensor with reference to the current position, and
by comparing the position of the virtual guide sensor and the guide tape data, determines whether or not the position of the virtual guide sensor lies within the range of the line segment data.

4. The automatic guided vehicle according to claim 1, wherein
a marker tape configured to make the automatic guided vehicle recognize a content of a command regarding travel of the automatic guided vehicle is disposed near the guide tape, and
the automatic guided vehicle further includes
an actual marker sensor configured to detect the marker tape,
a marker tape data storing unit configured to store data on a virtually set marker tape as marker tape data,
a virtual marker sensor processing unit configured to calculate a position of the virtual marker tape by using the current position and the marker tape data,
a marker sensor switching processing unit configured to switch between an output of the actual marker sensor and an output of the virtual marker sensor processing unit, and
a job command execution processing unit configured to determine, based on a position of the marker tape input via the marker sensor switching processing unit, whether or not to end a current job command for the automatic guided vehicle and execute a next job command.

5. The automatic guided vehicle according to claim 4, wherein
the marker tape data is line segment data having a center position, an attitude, and an entire length and a width of the virtual marker tape, and
the virtual marker sensor processing unit
sets an installation position of the actual marker sensor in the automatic guided vehicle as a position of a virtual marker sensor with reference to the current position, and
by comparing the position of the virtual marker sensor and the marker tape data, determines whether or not the position of the virtual marker sensor lies within a range of the line segment data.

6. The automatic guided vehicle according to claim 5, wherein
the actual marker sensor comprises two actual marker sensors that are arranged on respective both sides in a vehicle-width direction at a front of the automatic guided vehicle, and
the virtual marker sensor processing unit
sets each of installation positions of the two actual marker sensors in the automatic guided vehicle as a position of the virtual marker sensor, which comprises two virtual marker sensors, with reference to the current position, and
by comparing the positions of the two virtual marker sensors and the marker tape data, determines whether or not each of the positions of the two virtual marker sensors lies within the range of the line segment data.
